(19) United States
(12) Patent Application Publication
(10) Pub. No.: US 2025/0019085 A1
(43) Pub. Date: Jan. 16, 2025

(54) Primary Component For An Aircraft With Integrated Thermal Management

(71) Applicant: Premium Aerotec GmbH, Augsburg (DE)

(72) Inventors: Sebastian Weidinger, Augsburg (DE); Sascha Marzia, Augsburg (DE); Alfons Kaspar, Augsburg (DE); Sergej Kaufmann, Augsburg (DE)

(73) Assignee: Premium Aerotec GmbH, Augsburg (DE)

(21) Appl. No.: 18/677,173

(22) Filed: May 29, 2024

(30) Foreign Application Priority Data
May 30, 2023 (DE) 102023114120.1

(51) Int. Cl. B64D 33/08

(52) U.S. Cl. CPC B64D 33/08

(57) ABSTRACT

A primary component (100) for an aircraft (10) comprises a first surface (102) and a second surface (104) arranged opposite the first surface (102) as well as a heat exchanger (200). The heat exchanger (200) comprises a heat exchanger body (201) and a plurality of ports (212, 214, 222, 224). The heat exchanger (200) defines a first fluid circuit (210) and a second fluid circuit (220), wherein each fluid circuit is fluidically connected to two ports, respectively, and the first fluid circuit (210) is fluidically separated from the second fluid circuit (220). The heat exchanger body (201) is embedded in the primary component (100) in such a way that the heat exchanger body (201) is arranged between the first surface (102) and the second surface (104) of the primary component (100), and each of the plurality of ports (212, 214, 222, 224) is fluidically accessible either via the first surface (102) or via the second surface (104).

### TECHNICAL FIELD

The present description relates to a primary component for an aircraft with an integrated heat exchanger and an aircraft with such a primary component.

### TECHNICAL BACKGROUND

Technical devices are often characterized by the fact that heat is generated during the operation of these technical devices, which must be dissipated by thermal management in order to prevent damage to the technical device or to keep the temperature of the technical device within an approved temperature range.

For thermal management, heat exchangers are usually used to absorb heat at one location and release it at another. Such heat exchangers and other thermal management mechanisms require their own installation space in a technical device and therefore take up installation volume that is not available for other components.

Particularly in systems where installation space is a limited resource and the weight of the overall system is a relevant parameter, the installation of components for thermal management may pose a challenge.

### SUMMARY

It may therefore be regarded an object to provide an improved solution for thermal management in technical systems. In particular, it may be regarded an object to provide a space-saving and weight-saving solution for thermal management.

This object is solved by the object of the independent claim. Further embodiments are shown in the dependent claims and in the following description.

According to one aspect, a primary component for an aircraft is provided. The primary component comprises a first surface, a second surface arranged opposite the first surface, and a heat exchanger with a heat exchanger body and a plurality of ports. The heat exchanger defines a first fluid circuit and a second fluid circuit, wherein both the first fluid circuit and the second fluid circuit each have at least two ports and are fluidically connected to these ports. The first fluid circuit is fluidically separated from the second fluid circuit. The heat exchanger body is embedded in the primary component in such a way that the heat exchanger body is arranged between the first surface and the second surface of the primary component and each of the plurality of ports is fluidically accessible either via the first surface or via the second surface.

The primary component is, for example, a part of a load-bearing component or a structural component of an aircraft, such as the fuselage, the wing, a control surface or an engine housing. The design described herein has the benefit that the heat exchanger body can be integrated or embedded into the primary component in a space-saving manner without requiring additional installation space within the installation volume formed by the primary structure.

A heat exchanger is usually a separate component that has to be additionally installed in a technical device for thermal management. Such an additional heat exchanger therefore also requires installation space or installation volume. The primary component described here is based on the idea that the heat exchanger body is integrated into the primary component.

A heat exchanger is basically characterized by the fact that it has at least two separate fluid circuits and thermal energy is transferred from a first fluid circuit to a second fluid circuit. A fluid (for example a coolant or other fluid) in the first fluid circuit flows into the heat exchanger body at a high temperature and thermal energy is transferred to a fluid in the second fluid circuit via a partition wall (which preferably has a high thermal conductivity) between the two circuits. The fluid in the second fluid circuit absorbs the thermal energy and transports it away.

Each of the ports either protrudes above a surface of the primary component and is thus accessible for fluidic coupling or an external port can be inserted into a corresponding recess in the respective surface of the primary component and fluidically coupled with a port of the heat exchanger.

In one embodiment, the heat exchanger body has a first surface and a second surface opposite the first surface, wherein the first surface of the heat exchanger body and the second surface of the heat exchanger body are each at least partially adjacent to material of the primary component.

This means that the heat exchanger body is integrated or embedded within a material of the primary component.

The ports of the first fluid circuit and the second fluid circuit located on the heat exchanger body extend through the material of the primary component and are therefore accessible for fluidic coupling via the surfaces of the primary component.

The material of the primary component covers the surfaces of the heat exchanger body or lies against the surfaces of the heat exchanger body. Preferably, the heat exchanger body is completely embedded in the primary component and surrounded by the material of the primary component, except from the accesses to the ports for the first and second fluid circuits.

In a further embodiment, the material of the primary component is bonded to the first surface of the heat exchanger body and/or to the second surface of the heat exchanger body.

This means that the heat exchanger body can also contribute to the strength or stability of the primary component, because the heat exchanger body integrated into the primary component can absorb loads that act on the primary component.

In a further embodiment, the primary component comprises several material layers, and the heat exchanger body is arranged between at least two of these material layers.

At least one material layer of the primary component extends along the first surface of the heat exchanger body and at least one other material layer of the primary component extends along the second surface of the heat exchanger body.

The material layers adhere to the first surface or the second surface of the heat exchanger body. However, more than one material layer of the primary component can also be arranged on both sides of the heat exchanger body, i.e. along both the first surface and the second surface of the heat exchanger body.

In a further embodiment, the primary component consists of a fiber composite.

The primary component consists, for example, of several layers of fibers or a fiber fabric, which are embedded in a matrix material. The matrix material fills the space between the fibers. Such a composite material provides high strength combined with low weight and other material properties that are recognized as advantageous in aircraft construction.

The heat exchanger body is advantageously arranged between such fiber layers. As a result, the inherent strength of the heat exchanger body also contributes to the strength of the primary component.

In a further embodiment, the fiber composite contains glass fibers and/or carbon fibers.

In a further embodiment, the heat exchanger body is embedded in the primary component such that a first load path propagating through the primary component extends along the first surface of the heat exchanger body, and a second load path propagating through the primary component extends along the second surface of the heat exchanger body.

The heat exchanger body is, thus, integrated within the primary component. For example, the heat exchanger body is spaced apart from all surfaces of the primary component, so that the primary component forms a continuous material layer along all surfaces of the heat exchanger, which material layer serves as a load path. The material layer forming the primary component only has a few recesses to make the ports of the heat exchanger accessible for the first fluid circuit and the second fluid circuit.

Both the first load path and the second load path are absorbed and transferred by the material of the primary component in conjunction with the heat exchanger body.

In a further embodiment, the first load path extends between the first surface of the heat exchanger body and the first surface of the primary component, and the second load path extends between the second surface of the heat exchanger body and the second surface of the primary component.

In this variant, the primary component is constructed according to the principles of a sandwich component. The material or layers of the primary component surround the heat exchanger body and the heat exchanger body forms the core of a sandwich.

The material of the primary component or the layers of the primary component are bonded or otherwise connected to the heat exchanger body.

In a further embodiment, the heat exchanger body has a canted edge region.

In the canted edge region, the first surface of the heat exchanger body and the second surface of the heat exchanger body converge. This structure has the advantage that the material of the primary component has no stepped shape where the heat exchanger body is integrated into the primary component. Instead, the material of the primary component or the material layers surrounding the heat exchanger body run towards each other at the canted edge region at the angle specified by the edge region.

The canted edge region can be provided around the entire heat exchanger body. In cross-section, the heat exchanger body has a trapezoidal shape, for example. As a three-dimensional body, the heat exchanger can also be described as a truncated pyramid, whereby one surface of the heat exchanger body is smaller than the other surface of the heat exchanger body, and the smaller surface is connected to the other surface with inclined surfaces or merges into it.

In a further embodiment, the heat exchanger body comprises or consists of a metal, plastic or ceramic.

The heat exchanger body can, for example, be manufactured using additive manufacturing processes (so-called 3D printing or similar additive processes), whereby the heat exchanger body can be manufactured in almost any geometry to enable integration into a desired primary component of an aircraft.

In a further embodiment, at least one surface of the heat exchanger body is thermally coupled to a surface of the primary component.

This allows heat to be transferred from the heat exchanger body to the environment via the material of the primary component. In addition to the transfer of thermal energy from one fluid circuit to the other fluid circuit, this can provide additional cooling capacity.

According to a further aspect, an aircraft having a primary component as described herein is provided.

In one embodiment, the primary component is a structural component on a fuselage, a wing, a control surface, or an engine.

In particular, the primary component is a part of the fuselage, the wing, the control surface, or the engine and forms at least a part thereof.

This design allows the structure of the aircraft to be used for thermal management in the aircraft. No additional installation space is required for the heat exchanger because the heat exchanger body is integrated into the load-bearing structure of the aircraft. With the structure of the primary component described above, the heat exchanger body contributes to the mechanical strength of the primary component because the heat exchanger body is integrated or embedded into the primary component.

### BRIEF DESCRIPTION OF THE DRAWINGS

Some aspects are described in more detail below with reference to the appended drawings. The illustrations are schematic and not to scale. Same or similar reference signs refer to same or similar elements. It is shown in:

FIG. 1 a schematic representation of a heat exchanger;

FIG. 2 a schematic representation of a heat exchanger;

FIG. 3 a schematic representation of a primary component with a heat exchanger body integrated therein;

FIG. 4 a schematic representation of a primary component with a heat exchanger body integrated therein;

FIG. 5 a schematic representation of a primary component with a heat exchanger body integrated therein in a cross-sectional view;

FIG. 6 a schematic representation of a primary component with a heat exchanger body integrated therein;

FIG. 7 a schematic representation of an aircraft.

### DETAILED DESCRIPTION

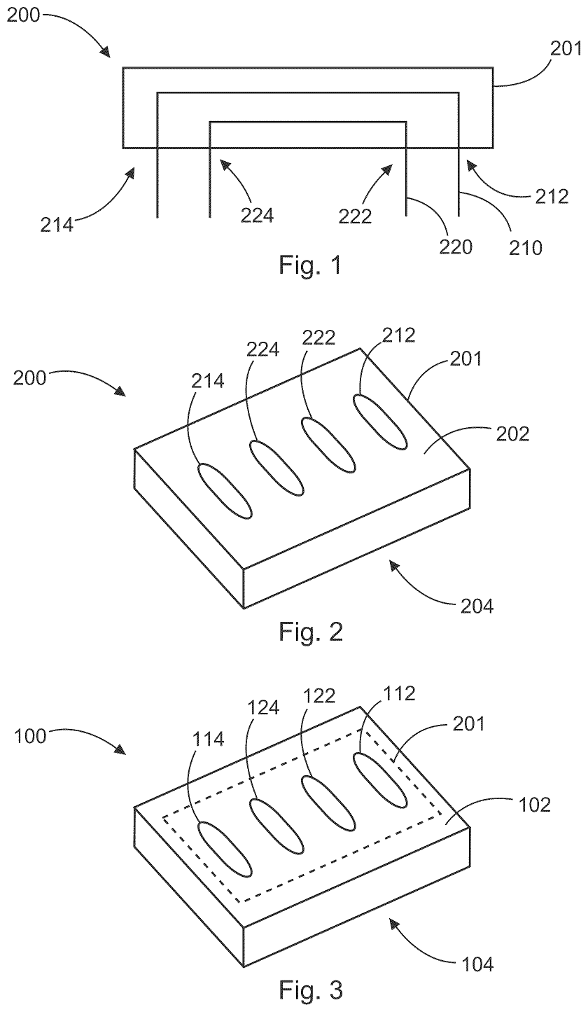

FIG. 1 shows a heat exchanger 200 with a heat exchanger body 201. Four ports are arranged on the heat exchanger body 201, which form a first fluid circuit 210 and a second fluid circuit 220. The first fluid circuit 210 has a first port 212 and a second port 214. The second fluid circuit 220 has a first port 222 and a second port 224.

The first fluid circuit 210 and the second fluid circuit 220 are fluidically separate volumes, i.e. there is no exchange of fluid between the first fluid circuit 210 and the second fluid circuit 220. However, the first fluid circuit 210 and the second fluid circuit 220 are separated by a partition wall which allows thermal energy to be transferred between the first fluid circuit 210 and the second fluid circuit 220.

For example, a heated fluid flows through the first fluid circuit and a relatively colder fluid flows through the second fluid circuit. In this way, thermal energy is transferred from the first fluid circuit to the second fluid circuit. The fluids in the two fluid circuits can flow in the same direction or in opposite directions at the same or different flow velocities.

FIG. 2 shows an isometric representation of the heat exchanger 200 of FIG. 1. The heat exchanger body 201 has a first surface 202 and a second surface 204. The first surface 202 and the second surface 204 are arranged opposite to each other. Four ports are arranged on the first surface, namely the first port 212 and the second port 214 of the first fluid circuit 210 and the first port 222 and the second port 224 of the second fluid circuit 220.

In the example of FIG. 2, the heat exchanger body 201 is shown as a cuboid, whereby this representation is to be understood as schematic and not limiting. In fact, the heat exchanger body 201 can be of any geometric shape in the context of the present description.

FIG. 3 shows a primary structure 100 with a heat exchanger body 201 integrated therein. The primary structure 100 has a first surface 102 and a second surface 104, the second surface 104 being opposite the first surface 102. The heat exchanger body 201 is integrated into the material of the primary structure 100 and is therefore shown with a dashed line in the illustration. However, in order to be able to introduce fluid into the heat exchanger body 201, the ports 212, 214, 222, 224 (see FIGS. 1 and 2) are accessible through corresponding recesses 112, 114, 122, 124 in the first surface 102 of the primary structure 100.

The recesses 112, 114, 122, 124 and also the ports 212, 214, 222, 224 can be arranged on the same surface 102, 104 of the primary component 100. However, for the embodiment of FIG. 3 and also all other variants of the primary structure 100, it is also conceivable that some ports 212, 214, 222, 224 and associated recesses 112, 114, 122, 124 are arranged on the first surface 102 and other ports 212, 214, 222, 224 and associated recesses 112, 114, 122, 124 are arranged on the second surface 104.

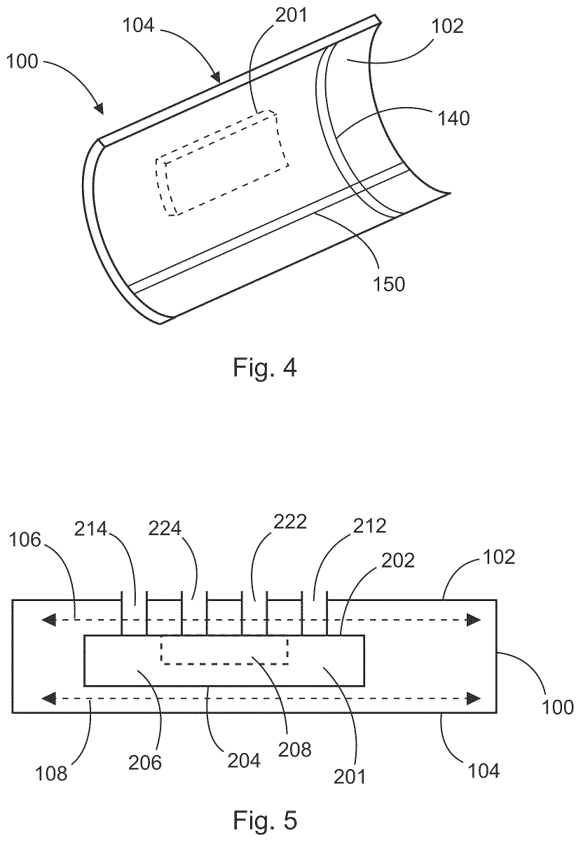

FIG. 4 shows a schematic representation of a primary component 100, which is designed as part of an aircraft fuselage. The heat exchanger body 201 is also shown here with dashed lines and is integrated into the component of the fuselage. A frame 140 and a stringer 150 are shown as examples on the primary component 100, whereby the frame 140 extends in the circumferential direction of the fuselage and the stringer 150 extends in the longitudinal direction of the fuselage and gives the fuselage stability.

FIG. 5 shows a cross-sectional view of the integration of the heat exchanger body 201 into the primary component 100. The heat exchanger body 201 is completely surrounded by material of the primary component 100, apart from the ports 212, 214, 222, 224, which are led out through or protrude from the first surface 102 of the primary component 100. In the heat exchanger body 201, a first volume 206 of the first fluid circuit between the port 212 and the port 214 is separated from a second volume 208 of the second fluid circuit between the port 222 and the port 224, shown by the dashed line in the heat exchanger body 201.

The ports 212, 214, 222, 224 can be formed in one piece with the heat exchanger body 201. For example, the heat exchanger body 201 is manufactured together with the ports 212, 214, 222, 224 in an additive manufacturing process.

The material layers of the primary component 100 can be placed around the ports 212, 214, 222, 224 and the subsequent production steps for the primary component can be carried out.

The first surface 202 of the heat exchanger body 201 is spaced from the first surface 102 of the primary component 100 and is covered with material of the primary component 100. Similarly, the second surface 204 of the heat exchanger body 201 is spaced from the second surface 104 of the primary component 100 and is covered with material of the primary component 100. The heat exchanger body is fully integrated into the material of the primary component, so that load paths 106, 108 extend through the material of the primary component 100 on the one hand between the surface 102 and the surface 202 and on the other hand between the surface 104 and the surface 204.

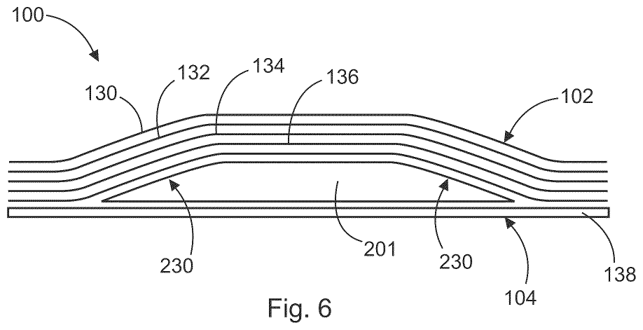

FIG. 6 shows a primary component 100 similar to the illustration in FIG. 5, in which a heat exchanger body 201 is integrated. The primary component 100 is designed as a fiber composite component with several layers 130, 132, 134, 136, 138, whereby the heat exchanger body 201 is surrounded on the one hand by layer 138 and on the other hand by the other layers 130 to 136 as well as additional layers.

The layers 130, 132, 134, 136, 138 may, for example, be fiber-reinforced plastic layers and may comprise glass fibers and/or carbon fibers. The heat exchanger body 201 can be introduced into the primary component 100 in one manufacturing process, so that the layers adjacent to the heat exchanger body 201 are bonded to the surfaces of the heat exchanger body 201. This achieves a high strength of the primary component 100 because the structure described here corresponds to a sandwich structure in which the heat exchanger body 201 has the function of the core layer and the surrounding material layers 130, 132, 134, 136, 138 have the function of the cover layers.

The heat exchanger body 201 has canted edge regions 230. The layers 130, 132, 134, 136, 138 extend along the canted edge regions 230 in the direction of the layer 138. The canted edge regions 230 can also be described as a tapered region.

The structure and function of the primary component 100 can be described as follows with reference to a specific application example:

The primary component 100 described here allows the integration of the function and of the system required for thermal management into the primary structure of an aircraft, e.g. in the outer skin or flaps or doors or covers of an aircraft or of an aircraft subsystem (pylon, etc.) and thus allows improved utilization of existing installation space, because the heat exchanger does not have to be arranged as a separate component in the available installation space within the internal volume formed by the primary structure. In addition to its strengthening function, the primary structure also acts as a heat exchanger of any size and shape.

In the case of a heat exchanger designed as a separate component, this separate component must be installed in the internal volume of the aircraft, which entails the need for installation space/installation volume, brackets, mounting means, etc. for integration. In contrast, the heat exchanger body referred to herein is integrated or embedded in the material of the primary structure.

The heat exchanger can be inserted as a core into a structural component using various methods, such as additive manufacturing, welding, soldering or bonding. The heat exchanger body is then covered with fiber-reinforced layers, as shown in FIG. 6. Additive manufacturing processes can be used to realize any geometry of the heat exchanger body, which also applies to the port area between the heat exchanger volume and the supply line at ports 212, 214, 222, 224.

With the design described here, the ambient air flowing along a surface of the primary component 100 can be used as an additional heat sink without additional RAM-Air channels. By omitting installation of a separate heat exchanger in the installation volume, there is a smaller space requirement due to functional integration and the reduction of brackets and connection points.

In addition to providing strength and stiffness, the primary structure takes on other tasks and thus becomes a multifunctional element. Thermal management functions (heat exchanger or piping) are integrated into the primary structure. Existing restrictions in the dimensions of the heat exchanger can be circumvented through this integration. Access to the heat exchanger body for the ports of the fluid circuits is possible on one or more sides. The primary structure may be made of metal or a fiber-plastic composite. The heat exchanger body may be made of metal, plastic or ceramic or may comprise such a material.

When using additive manufacturing processes, the ports can be positioned anywhere on the heat exchanger body. The use of additive manufacturing processes enables defined inlets and outlets for just one fluid at any point on the heat exchanger body. The functional volume within the heat exchanger body can be designed as required (e.g., as a gyroid or as a plate or fin heat exchanger). Depending on the application and the manufacturing process used, the functional sandwich core, i.e., the heat exchanger body, can either be made of metal (e.g. Ti or Al) or plastic.

The heat exchanger bodies can be manufactured in any geometry, not only in cuboid shapes. The heat exchanger body can be single or multi-curved to allow integration into curved primary structure components.

For example, the heat exchanger body can be integrated into the outer skin or the frame of the fuselage. Pipes that provide the inflow and outflow of fluid to the first fluid circuit and the second fluid circuit can be integrated into the outer skin, the frame or stringers, and frames of an aircraft. The heat exchanger body can be designed in any functional configuration: heat exchanger with same flow direction, heat exchanger with opposite flow direction, crossflow heat exchanger, with single-sided or multi-sided supply.

The primary component described here can be used in particular in aircraft where a high heat load is generated and needs to be distributed or dissipated accordingly. This is the case, for example, when using propulsion systems based on liquid hydrogen. Various concepts can be used here, including the direct combustion of gaseous hydrogen in the engine and the generation of electrical energy using a fuel cell. Due to the low volumetric energy density of hydrogen, in both applications it is stored in a cryogenic state in tanks, vaporized in a defined manner and finally used in a gaseous state to generate energy. When a fuel cell is used to generate energy, a significant amount of heat is generated that must be removed from the fuel cell. Ideally, this heat is transported as short a distance as possible in order to minimize parasitic heat input into the structure and also to keep the weight of the piping as low as possible.

With the primary component described here, it is possible to integrate a large number of heat exchangers in almost any position in an aircraft without requiring separate installation space. This means that heat exchangers can be placed in an aircraft as required. This means that heat can be released close to the heat source. The heat can also be dissipated directly to the environment by integrating it into a primary component, which can increase the cooling capacity.

For military aircraft, there may be increased requirements for the ability to detect electromagnetic waves (radar). These requirements may mean that the number and size of air inlets and outlets must be optimized, which directly influences the architecture of the thermal management system. The amount of heat to be dissipated can also be increased by an increasing number of electronic components, e.g. communication paths, more powerful radar and avionics. Integrating the heat exchanger into a primary component improves space utilization and increases the amount of thermal energy that can be dissipated, which can contribute to a higher overall system performance.

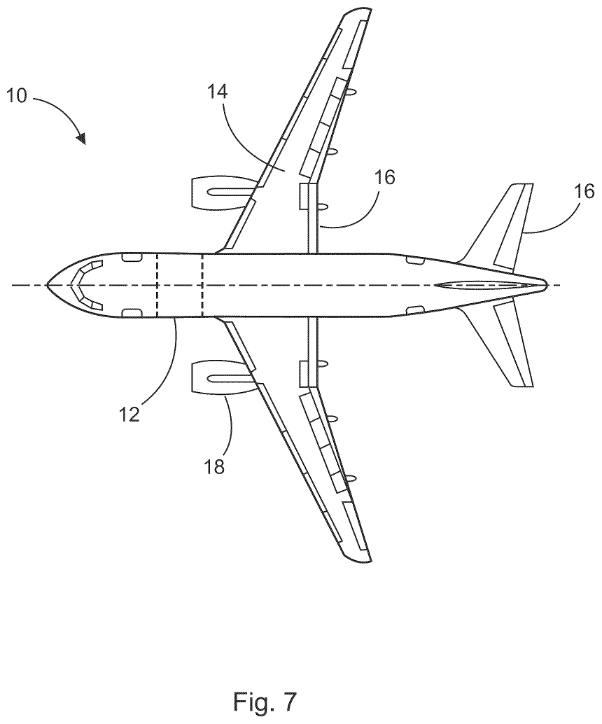

FIG. 7 shows a schematic representation of an aircraft 10. The primary component 100 as described above can be arranged in the fuselage 12, a wing 14, a control surface 16 or the engine 18.

In addition, it should be noted that “including” or “comprising” does not exclude other elements or steps and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

### List of Reference Signs

10 aircraft
12 fuselage
14 wing
16 control surfaces
18 engine
100 primary component
102 first surface
104 second surface
106 first load path
108 second load path
112 recess
114 recess
122 recess
124 recess
130 layer
132 layer
134 layer
136 layer
138 layer
140 frame
150 stringer
200 heat exchanger
201 heat exchanger body
202 first surface
204 second surface
206 first volume
208 second volume
210 first fluid circuit
212 first port
214 second port
220 second fluid circuit
222 first port
224 second port
230 canted edge region

1. A primary component (100) for an aircraft (10), the primary component (100) comprising:
a first surface (102);
a second surface (104) arranged opposite the first surface (102);
a heat exchanger (200) with a heat exchanger body (201) and a plurality of ports (212, 214, 222, 224);
wherein the heat exchanger (200) defines a first fluid circuit (210) and a second fluid circuit (220), wherein the first fluid circuit (210) and the second fluid circuit (220) is fluidically connected to two ports, respectively, and the first fluid circuit (210) is fluidically separated from the second fluid circuit (220);
wherein the heat exchanger body (201) is embedded into the primary component (100) in such a way that the heat exchanger body (201) is arranged between the first surface (102) and the second surface (104) of the primary component (100), and each of the plurality of ports (212, 214, 222, 224) is fluidly accessible via the first surface (102) or via the second surface (104).

2. The primary component (100) according to claim 1,
wherein the heat exchanger body (201) comprises a first surface (202) and a second surface (204) arranged opposite the first surface (202);
wherein the first surface (202) of the heat exchanger body (201) and the second surface (204) of the heat exchanger body (201) are each at least partially adjacent to material of the primary component (100).

3. The primary component (100) according to claim 2,
wherein the material of the primary component (100) is bonded to the first surface (202) of the heat exchanger body (201) and/or to the second surface (204) of the heat exchanger body (201).

4. The primary component (100) according to one of the preceding claims,
wherein the primary component (100) comprises a plurality of material layers (130, 132, 134, 136, 138) and the heat exchanger body (201) is arranged between at least two of these material layers.

5. The primary component (100) according to claim 4,
wherein the primary component (100) consists of a fiber composite.

6. The primary component (100) according to claim 5,
wherein the fiber composite contains glass fibers and/or carbon fibers.

7. The primary component (100) according to one of the preceding claims,
wherein the heat exchanger body (201) is embedded in the primary component (100) such that a first load path (106) propagating through the primary component (100) extends along the first surface (202) of the heat exchanger body (201), and a second load path (108) propagating through the primary component (100) extends along the second surface (204) of the heat exchanger body (201).

8. The primary component (100) according to claim 7,
wherein the first load path (106) extends between the first surface (202) of the heat exchanger body (201) and the first surface (102) of the primary component (100);
wherein the second load path (108) extends between the second surface (204) of the heat exchanger body (201) and the second surface (104) of the primary component (100).

9. The primary component (100) according to one of the preceding claims,
wherein the heat exchanger body (201) comprises a canted edge region (230).

10. The primary component (100) according to one of the preceding claims,
wherein the heat exchanger body (201) comprises or consists of a metal, plastic or ceramic.

11. The primary component (100) according to one of the preceding claims,
wherein at least one surface (202, 204) of the heat exchanger body (201) is thermally coupled to a surface (102, 104) of the primary component (100).

12. An aircraft (10). comprising a primary component (100) according to any one of claims 1 to 11.

13. The aircraft (10) according to claim 12.
wherein the primary component (100) is a structural component on a fuselage (12), a wing (14), a control surface (60), or an engine (18).
